(19) United States
(12) Patent Application Publication
(10) Pub. No.: US 2011/0226579 A1
(43) Pub. Date: Sep. 22, 2011

(54) CENTRIFUGALLY ASSISTED CLUTCH

(75) Inventors: Brian Robert Ley, Washington, MO (US); John Alex Settles, Cuba, MO (US); Thomas Christopher Mounce, Steelville, MO (US)

(73) Assignee: ACE MANUFACTURING & PARTS COMPANY, Sullivan, MO (US)

(21) Appl. No.: 12/725,982

(22) Filed: Mar. 17, 2010

(51) Int. Cl. F16D 13/48

(52) U.S. Cl. 192/89.1

(57) ABSTRACT

A friction clutch assembly connects driving and driven shafts and has a pressure plate axially moveable between an engaged position transmitting torque from the driving shaft to the driven shaft and a disengaged position. The assembly includes levers and a plurality of centrifugal-assist weights on the levers adjacent outer ends of the levers. The centrifugal-assist weights are arranged to apply an increased force urging the pressure plate to its engaged position upon rotation of the cover and the levers. The centrifugal-assist weights are suitably configured to provided the desired amount of increased force.

### BACKGROUND OF THE INVENTION

This invention relates generally to friction clutches, and in particular to a clutch assembly that transmits a calibrated amount of centrifugal force.

Friction clutches are widely used in trucks and other automotive vehicles to selectively connect a driving shaft which is a source of rotational power, such as an engine crankshaft, to a driven shaft, such as a transmission input shaft. A typical clutch has a moveable pressure plate connected for rotation with the driving shaft and a friction disk connected for rotation with the driven shaft. When the pressure plate is moved to a position where it clamps the friction disk in operative engagement with a flywheel on the end of the driving shaft, the driven shaft rotates with the flywheel and torque is transmitted from the driving shaft to the driven shaft. When the pressure plate is moved to a position where the friction disk is disengaged from the flywheel, essentially no torque is transmitted and a driver of the vehicle is free to shift gears of the transmission. Existing clutches to which the present invention applies may include multiple pressure plates and friction disks that are compressed by action of the clutch to engage the flywheel and driven shaft.

One or more springs mounted on the cover plate bias the pressure plate to the position where the friction disk engages the flywheel. In one existing design, a conical spring diaphragm is mounted on the cover to exert an axial force on the pressure plate in its extended conical position and to release the pressure plate when flattened by the force applied by a release bearing initiated by depressing the clutch pedal of the vehicle. The spring must be provided with a tension that is sufficiently high to exert adequate pressure on the pressure plate to prevent slipping of the clutch while still permitting ease of disengagement of the clutch through the clutch pedal of the vehicle. An example of this design is described in U.S. Pat. No. 7,982,661, assigned to Ace Manufacturing & Parts Company in Sullivan, Mo. In another existing design, a series of coil compression springs seated on the cover urge a series of levers into pressure engagement with the pressure plate. Depression of the clutch pedal to overcome the force applied by these springs causes the clutch to disengage. An example of this design is described in published application Ser. No. 11/460,491, published as Pub. No. 2006/0260904A1, assigned to Ace Manufacturing & Parts Company in Sullivan, Mo.

Recent trucks and other automotive vehicles include engines of significantly greater horsepower and torque that require clutches which transmit more power. Each clutch must provide a correspondingly greater plate load to hold the pressure plate in clamped engagement with the friction disk. To facilitate a larger plate load, some clutches include springs of increased size or a greater number of springs (including compression springs) to apply a larger force urging the pressure plate against the friction disk. Unfortunately, these springs can detrimentally increase weight and volume of the clutch. Further, since the driver must oppose a larger spring force when pressing upon the foot pedal, the clutch is more difficult to operate. These clutches are complex, costly, and less reliable. Also, while existing centrifugally assisted clutch designs may reduce the amount of pedal force required to disengage the clutch, these designs have drawbacks.

### SUMMARY OF THE INVENTION

In general, a friction clutch assembly of this invention is used for connecting driving and driven shafts, the driving shaft having a flywheel thereon. The clutch assembly comprises a pressure plate adapted for operative attachment to the driven shaft for rotation therewith about an axis of rotation. The pressure plate is axially moveable between an engaged position wherein the pressure plate applies a force to clamp a friction disk of the driven shaft in operative engagement with a flywheel of the driving shaft thereby to transmit torque from the driving shaft to the driven shaft and a disengaged position wherein the pressure plate does not clamp the friction disk and substantially no torque is transmitted. The clutch assembly includes a cover adapted for mounting on the flywheel in a fixed axial position relative to the flywheel and for rotation in unison with the flywheel about the axis of rotation. A thrust bearing assembly is rotatable about the axis of rotation in unison with the cover and is movable along the axis of rotation in a first direction toward the pressure plate and in a second direction away from the pressure plate. A plurality of coil compression springs reacts against the cover to bias the thrust bearing assembly in said first direction. A plurality of levers are rotatable in unison with the cover, the levers being arranged around the axis of rotation and extending in generally radial directions with respect to the axis of rotation. The levers have inner ends connected to the thrust bearing assembly such that upon movement of thrust bearing assembly in the first direction the levers are adapted to pivot in one direction to apply a generally axial force urging the pressure plate to the engaged position, and such that upon movement of thrust bearing assembly in the second direction the levers are adapted to pivot in an opposite direction to permit movement of said pressure plate to said disengaged position. The clutch assembly further comprises a plurality of centrifugal-assist weights on the levers adjacent outer ends of the levers. The centrifugal-assist weights are arranged to apply an increased force urging the pressure plate to its engaged position upon rotation of the cover and the levers. Each lever comprises a lever body having a fulcrum between the inner and outer ends of the lever for pivoting contact with the pressure plate. Each centrifugal-assist weight has a center of mass located a distance in the range of 1.0-1.5 in. in a radial direction outward from said fulcrum.

Alternatively or in combination, each centrifugal-assist weight described in the preceding paragraph has an overall weight in the range of 160-500 grams.

Other objects and features of the present invention will be in part apparent and in part pointed out hereinafter.

### BRIEF DESCRIPTION OF THE DRAWINGS

FIG. 1 is a top perspective of a first embodiment of the friction clutch assembly;

FIG. 2 is a view similar to FIG. 1 but with a portion of the cover cut away to show details of the clutch assembly;

FIG. 3 is a top plan of the clutch assembly of FIG. 1;

FIG. 4 is an enlarged section taken on lines 4-4 of FIG. 3 showing the clutch in an engaged position;

FIG. 5 is an enlarged portion of FIG. 4;

FIG. 6 is a view similar to FIG. 4 but showing the clutch in a disengaged position;

FIG. 7 is an enlarged portion of FIG. 6;

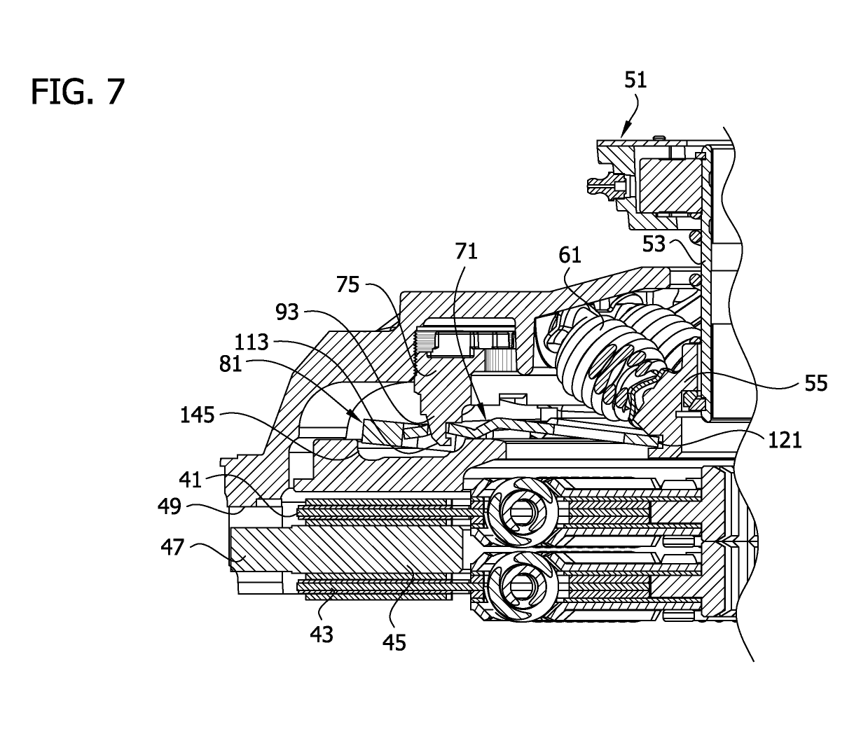

FIG. 8 is an enlarged perspective of a one lever and a centrifugal-assist weight attached to the lever;

FIG. 9 is an enlarged section taken on line 9-9 of FIG. 8; and

FIG. 10 is a graph plotting “Added Weight Load” (due to different combinations of levers and centrifugal-assist weights) versus rpm.

Corresponding reference characters indicate corresponding parts throughout the several views of the drawings

### DETAILED DESCRIPTION OF PREFERRED EMBODIMENTS

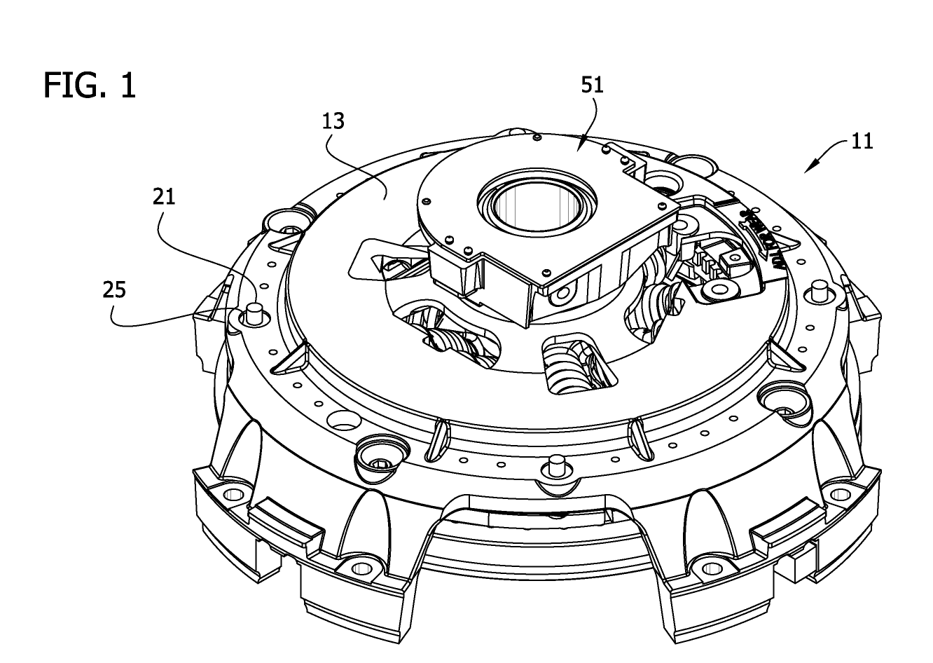

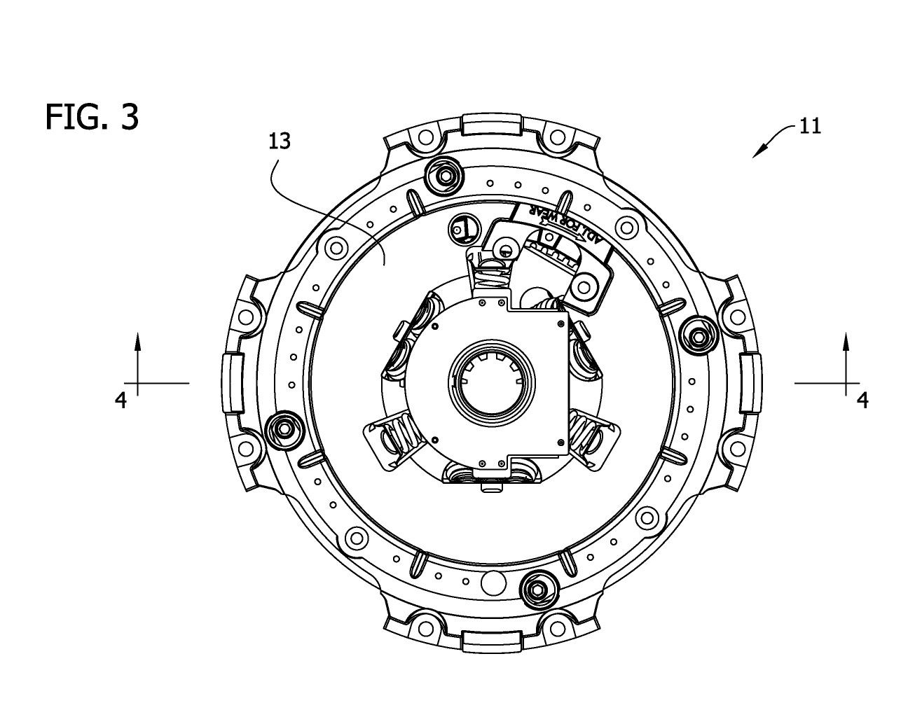

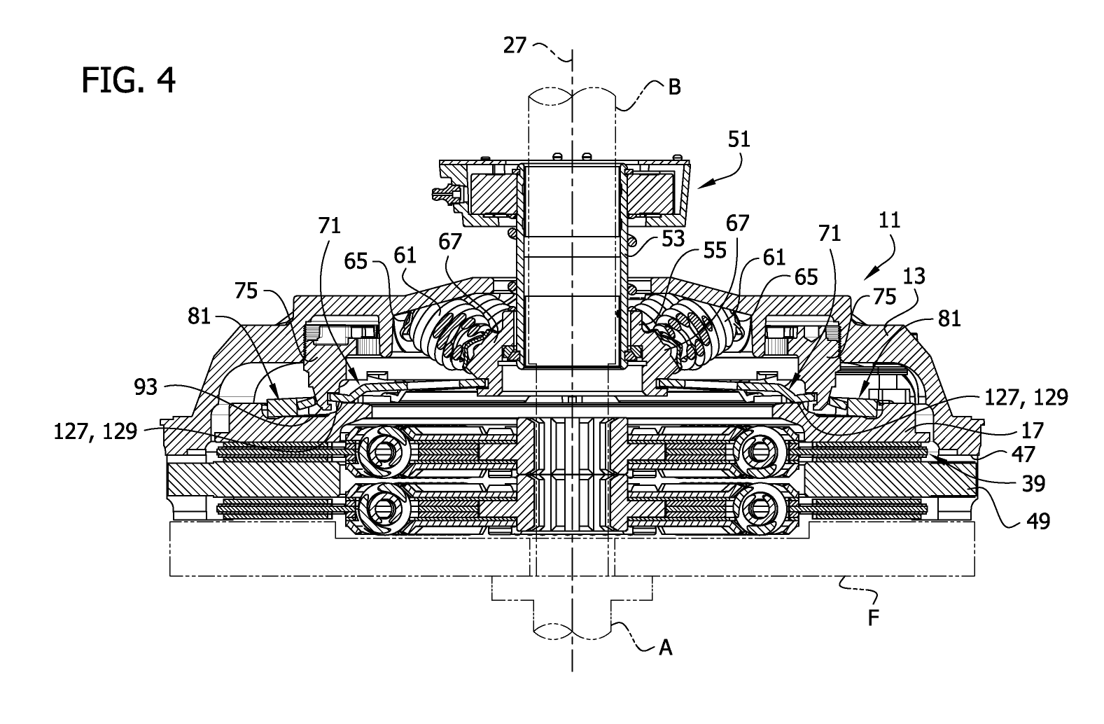

Referring now to the drawings and in particular to FIGS. 1-6, a friction clutch assembly of the present invention is indicated generally at 11. The clutch assembly interconnects a powered, driving shaft A (FIG. 4) to a driven shaft B. Typically the driving shaft A is an engine crankshaft of an automotive vehicle (e.g., truck) which is attached to a flywheel F, and the driven shaft B is a transmission gearbox input shaft. The driving shaft A and driven shaft B are axially aligned and can be operatively connected through the clutch assembly 11 so that torque is transmitted and the shafts rotate together. A driver of the vehicle uses the clutch assembly 11 to selectively disconnect the shafts A, B interrupting the transmission of torque, in order to permit a gear shifting operation in the transmission.

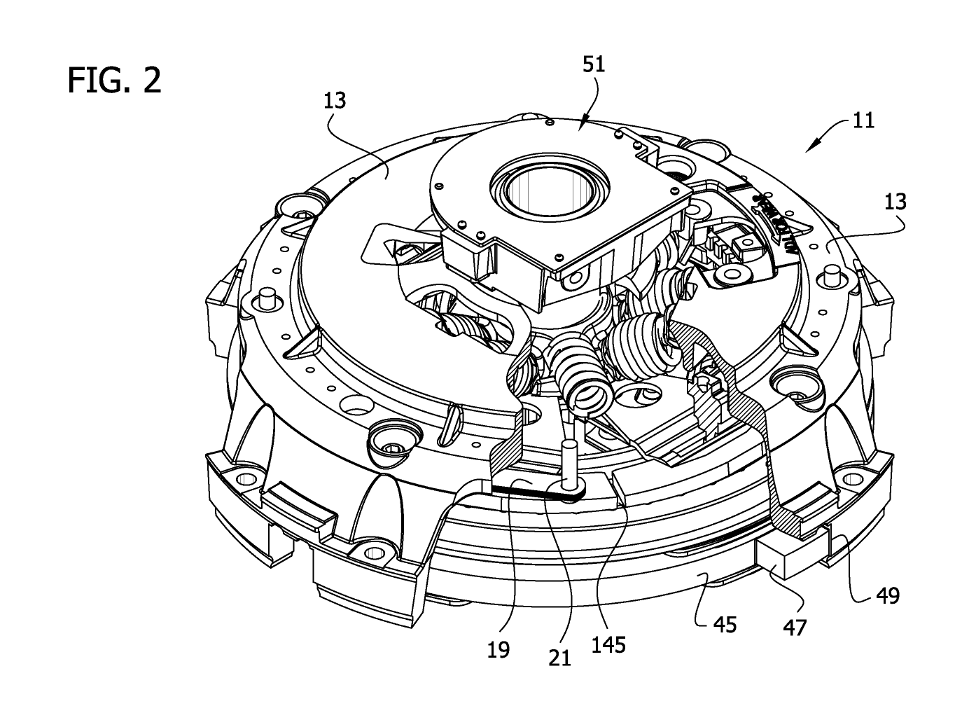

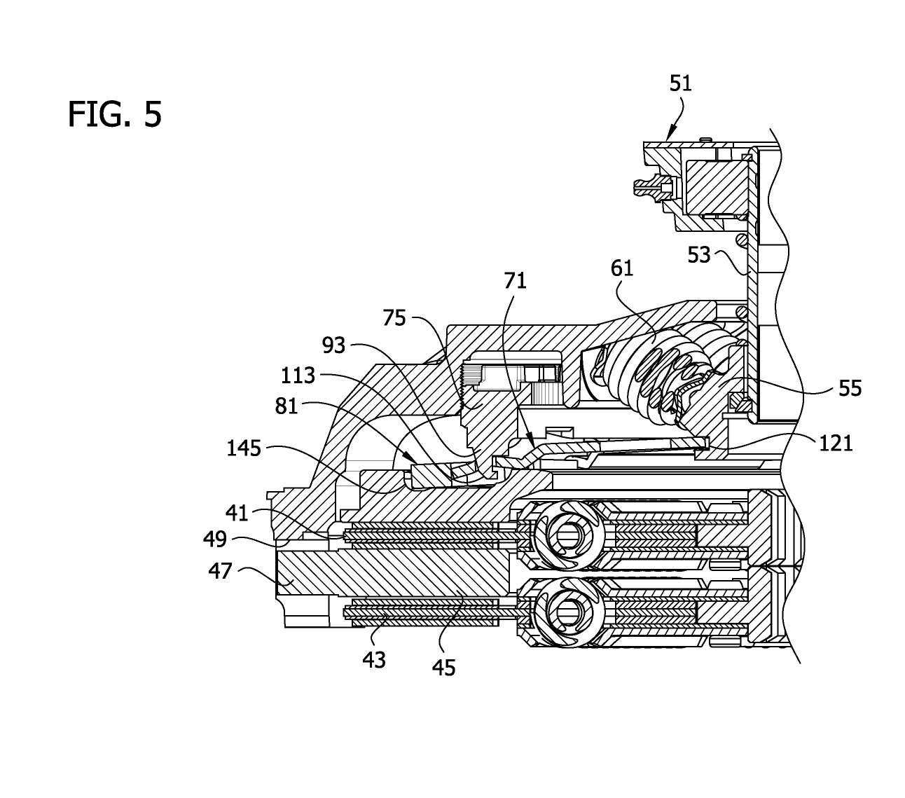

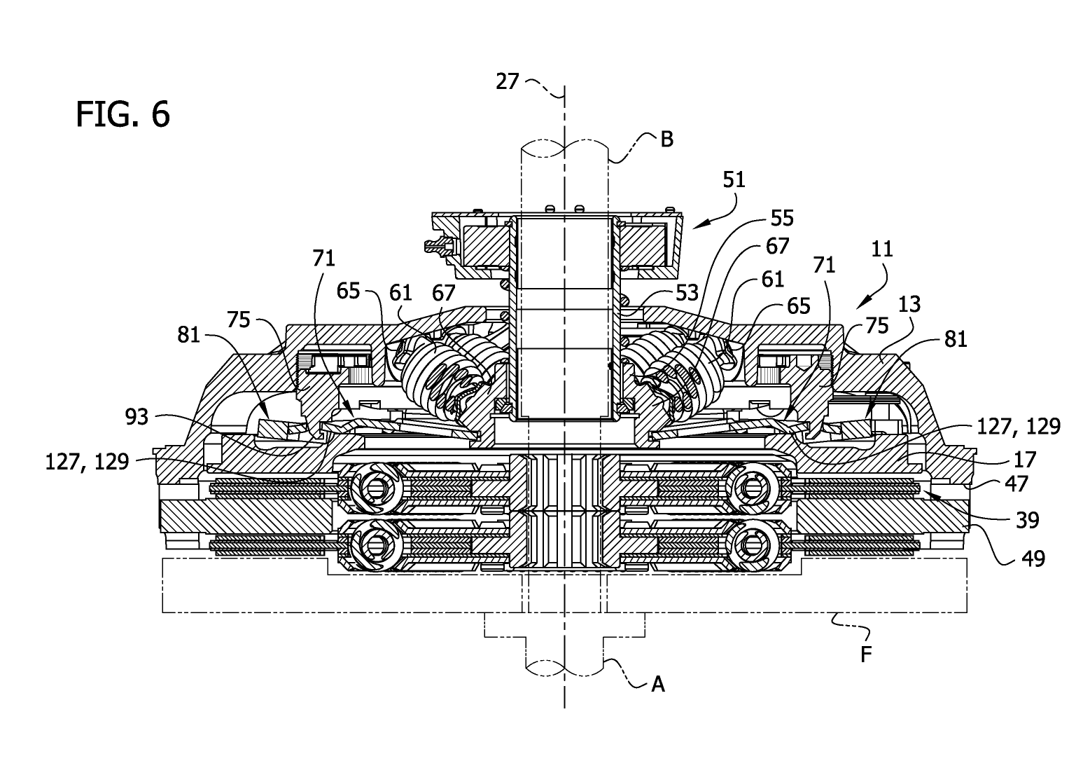

The clutch assembly 11 comprises a cover 13 mounted on the flywheel F in a fixed axial position relative to the flywheel for rotation in unison with the flywheel, and a primary pressure plate 17 operatively attached to the cover 13 by a series of links 19 (FIG. 2), each having a first end pivotally secured to the pressure plate 17 by a fastener (not shown) and a second end pivotally secured to the cover by a pin 21 on the link extending into an opening 25 in the cover. The flywheel F, cover 13 and pressure plate 17 rotate in unison about an axis 27 of the driven shaft B. The pressure plate 17 is axially moveable between an engaged position (FIG. 4) wherein the pressure plate applies a force to clamp a friction disk assembly 39 on the driven shaft B into operative engagement with the flywheel F of the driving shaft A thereby to transmit torque from the driving shaft to the driven shaft, and a disengaged position (FIG. 6) wherein the pressure plate 17 does not clamp the friction disk assembly 39 and substantially no torque is transmitted. In the illustrated embodiment, the friction disk assembly 39 includes a first set of friction disks 41, a second set of friction disks 43, and an intermediate pressure plate 45 sandwiched between the two sets of friction disks 41, 43 (see FIG. 5). As will be understood by the skilled person, the friction disks 41, 43 have driving connections (e.g., splined connections) with the driven shaft B for transmitting torque to the shaft. The intermediate pressure plate 45 has radial lugs 47 (FIG. 5) which project into openings 49 in the cover 13, such that the plate 45 and cover 13 rotate together. It will be understood that the friction disk assembly 39 may have other configurations.

In the illustrated embodiment, the clutch assembly 11 includes a thrust bearing assembly 51 which slides on the driven shaft B in an axial direction in response to depression and release of the clutch pedal. The thrust bearing assembly 51 includes a sleeve 53 which is both rotatable and slidable on the driven shaft B, and a member which, in this embodiment, comprises a retaining collar 55 rotatable relative to the sleeve and capable of limited axial movement relative to the sleeve. The retaining collar 55 is coupled to the cover 13 such that the collar 55 and sleeve 53 rotate in unison with the cover 13, as will be understood by those skilled in this field. For additional details, reference may be made to U.S. Pat. No. 3,394,788 which is incorporated herein by reference for all purposes consistent with this disclosure.

The sleeve 53 and retaining collar 55 are urged by a number of coil compression springs 61 toward the position shown in FIG. 4 in which the clutch is engaged. One end of each spring 61 is seated on a boss 65 on the cover 13 (see FIG. 4) of the clutch and the opposite end of the spring is seated on a boss 67 on the retaining collar 55 of the thrust bearing assembly 51. The springs 61 can be mounted in other ways. Further, the number of springs 61 may vary from two to six or more, nine such springs being shown spaced around the driven shaft B in the illustrated embodiment.

A number of levers 71 extend between the retaining collar 55 and a member 75 on the cover 13. In this particular embodiment the member 75 is an adjustment ring threaded on the cover to move axially with respect to the cover as needed to compensate for wear of the friction disks 41, 43. Each such lever 71 is adapted to pivot relative to the cover 13 and is configured for contact with the primary pressure plate 17. The number of levers 71 may vary from one to six or more, six such levers being shown equally spaced around the axis of rotation A of the driven shaft B. The thrust bearing assembly 51 and levers 71 are biased by the springs 61 to move to the clutch-engaged position shown in FIG. 4 in which each lever 71 pivots in one direction relative to the adjustment ring 75 and cover 13 thereby to apply a generally axial force urging the primary pressure plate 17 to its engaged position, as shown in FIG. 4. On release of this spring bias, i.e., when the clutch pedal is depressed to move the thrust bearing assembly 51 in an axial direction away from the flywheel F, thereby compressing the springs 61, the levers 71 move to the clutch-disengaged position shown in FIG. 6 in which each lever pivots in an opposite direction to permit movement of the pressure plate 17 to its disengaged position.

The clutch assembly 11 further comprises a plurality of centrifugal-assist weights 81 on at least two of the levers 71 and preferably all of the levers 71. In the illustrated embodiment, one such weight 81 is provided on each lever 71, although other arrangements are possible. Each weight 81 assists its respective lever 71 in urging the pressure plate 17 toward its engaged position. As a result, the force exerted by the pressure plate 17 to press the friction disk assembly 39 against the flywheel F is increased to provide a greater coupling force for driving the driven shaft B. As a result, smaller and/or fewer springs 61 can be used to maintain the clutch engaged. This is advantageous because less force is required to disengage the clutch assembly 11, making the gear-shifting process easier and less fatiguing.

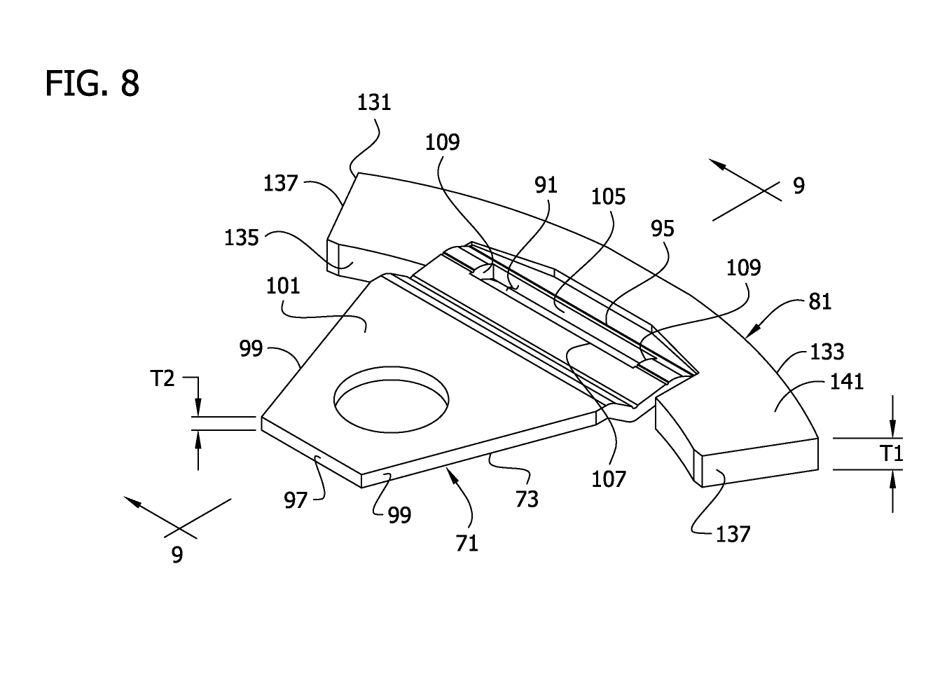

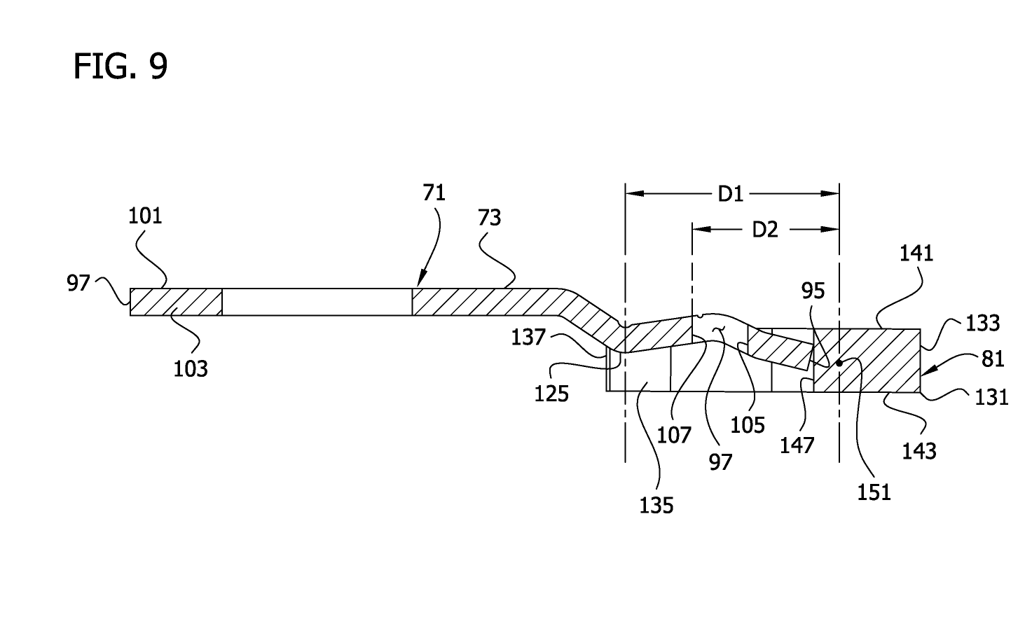

Referring to FIGS. 8 and 9, each lever 71 comprises a lever body 73 that is generally wedge-shaped to have a relatively wide outer end with an opening 91 for receiving a lug 93 depending from the adjustment ring 75, and a narrower inner end adjacent the retaining collar 67. Other lever shapes are possible. The lever body 73 has a perimeter defined by radial outer edge 95, a radial inner edge 97, and opposite side edges 99 that taper in an inward direction from the outer edge 95 to the inner edge 97. The lever body 73 also has first (upper) and second (lower) surfaces 101 and 103, respectively, as viewed in FIGS. 8 and 9. The lever 71 may be formed as a one-piece member stamped from a sheet of metal, or otherwise formed. The opening 91 in the lever body 73 is generally rectangular and has a radial outer edge 105, a radial inner edge 107, and opposite side edges 109. Other opening shapes are possible. The radial inner edge 107 of the opening 91 is received in a notch 113 in the lug 93 on the adjustment ring 75 (see FIG. 5). Alternatively, the inner edge 107 can be received in a recess in some other member on the cover 13, and such member could be a part which is separate and discrete from the cover or a part which is formed as an integral (one-piece) portion of the cover. The inner edge 97 of the lever body 73 is received in a circumferential recess 121 in the retaining collar 55. The second surface 103 (lower surface in FIGS. 8 and 9) of the lever body has a fulcrum 125 configured for pivoting contact with a corresponding contact area 129 of the primary pressure plate 17 (see FIG. 4).

Each centrifugal-assist weight 81 comprises a mass of material (e.g., metal) attached to a respective lever 71 at or adjacent its outer end. Desirably, the weight is formed integrally with the lever, e.g., cast or stamped as one piece with the lever. Alternatively, the weight 81 can be formed as a separate piece and then suitably attached to the lever, as by welding, adhesives, or fasteners. In the embodiment of FIGS. 8 and 9, the weight 81 comprises a plate or slab 131 of metal having a perimeter defined by a radial outer edge 133, a radial inner edge 135, and opposite end edges 137. The weight 81 also has first (upper) and second (lower) surfaces 141, 143, respectively. As illustrated, the perimeter of the centrifugal-assist weight 81 lies substantially entirely outside the perimeter of the lever body 73. In particular, the weight 81 extends outward in a radial direction beyond the outer edge 95 of the lever body and outward in a circumferential (lateral) direction beyond the side edges 99 of the lever body. The weight has a generally uniform thickness T1 greater than the thickness T2 of the lever 81. Desirably, the weight 81 is configured to have a perimeter contour that matches the pressure plate 17. Thus, in the illustrated embodiment, the outer edge 133 of the weight 81 is curved on an arc substantially centered on axis 27 to fit inside a curved depression 145 in the upper surface of the pressure plate 17 (see FIGS. 2 and 5). The weight 81 may have other shapes and sizes. The outer edge 95 of the lever body 73 is received in a notch 147 in the inner edge 135 of the weight 81. The weight 81 may have other configurations. For example, the perimeter of the weight 81 may overlap the perimeter of a respective lever 71.

The size, shape and geometry of the centrifugal-assist weight 81 will vary depending on such factors as the space available, the amount of force to be applied by the lever 71 to the primary pressure plate 17, and the configuration of the pressure plate 17 and adjacent clutch parts. In the embodiment of FIGS. 8 and 9, the weight 81 has a center of mass 151 located a distance D1 in the range of 1.0-1.5 in. in a radial direction outward from the fulcrum 125 of the lever 71, and a distance D2 in the range of 0.5-1.25 in. in a radial direction outward from the outer edge 105 of the opening 91 in the lever. The overall weight of the centrifugal-assist weight 81 is in the range of 160-500 grams. This compares to the weight of the lever 71 itself which typically is in the range of 150-325 grams. Thus, the weight of the lever 71 can be more or less than the weight of the centrifugal-assist weight. In general, the ratio of the weight of the centrifugal-assist weight 81 to the weight of the lever 71 is in the range of about 0.3-2.025. By way of example but not limitation, the following are values for exemplary lever 71 and centrifugal-assist weight 81 combinations:

| Lever | Centrifugal-Assist |
|---|---|
| Weight (g) | Weight (g) |
| 150 | 160 |
| 176 | 165 |
| 176 | 224 |
| 325 | 500 |

Regardless of the shape of each centrifugal-assist weight 81, it is preferable (although not essential) that the lever 71 be configured so that it remains entirely within the cover 13 as it pivots between its clutch-engaged and clutch-disengaged positions. This configuration provides greater compactness to the clutch assembly and avoids interference with other parts of the clutch.

When the clutch is engaged, the levers 71 and centrifugal-assist weights 81 assume the positions shown in FIG. 4 in which the fulcrum 125 of each lever contacts the primary pressure plate 17 and exerts an axial force on the pressure plate which is increased by the added mass of the weight 81. As the speed of rotation of the assembly increases, the centrifugal force exerted on each lever 7 and centrifugal-assist weight 81 will cause this combination to pivot with increasing force about the fulcrum 125 to apply an increasing axial force to the pressure plate 17. Preferably, for the sake of uniform load distribution on the pressure plate 17, the axial forces exerted by the levers 71 and weights 81 are about the same from lever to lever, although it is contemplated that there may some variation between levers 71. As the rotation of the clutch assembly decreases, as during a shifting event, the centrifugal force on each lever and weight combination 71, 81 decreases, resulting in a decreasing axial force on the pressure plate 17. Depression of the clutch pedal causes movement of the thrust bearing assembly 51 in an axial direction away from flywheel F, with concurrent compression of the springs 61, to permit disengagement of the clutch to permit the shifting event to occur (FIG. 6). After the event has been completed, the clutch pedal is released, and the springs 61 urge the clutch assembly 11 to move in an opposite axial direction back to its engaged position (FIG. 4). As noted previously, because the centrifugal-assist weights 81 assist in providing the necessary axial force against the pressure plate 17 to maintain the proper coupling between the pressure plate 17 and the flywheel F (through the friction disk assembly 39), the springs 61 can apply less force to the thrust bearing assembly 51 compared to conventional designs. As a result, less effort is required by the driver to disengage the clutch, and driver fatigue over time is reduced.

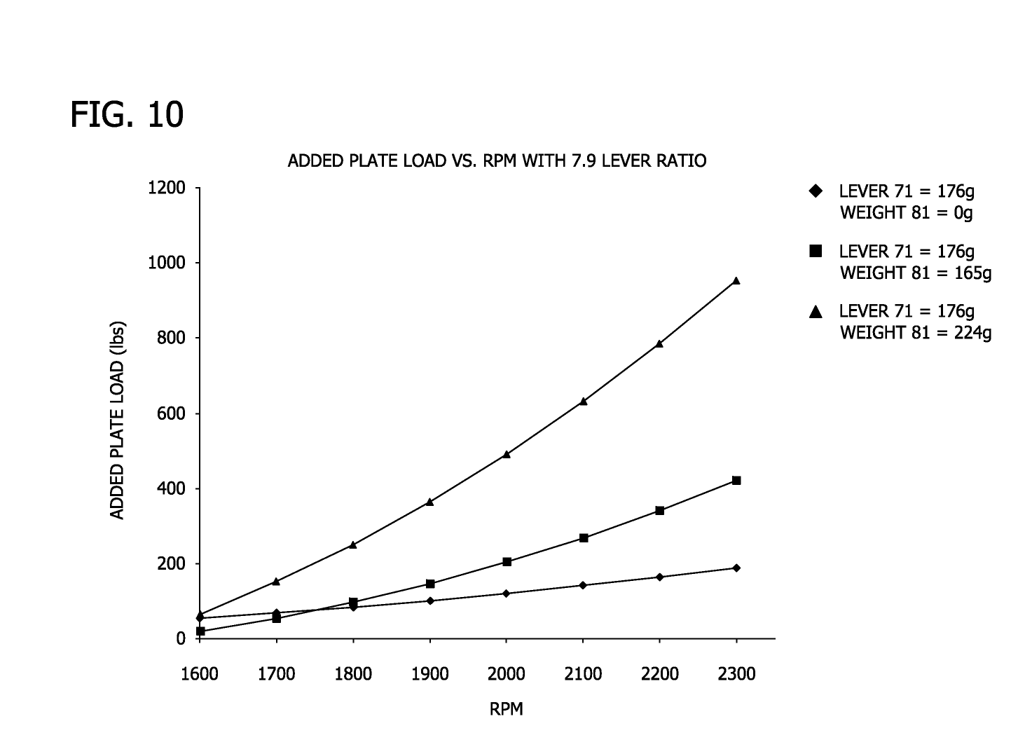

FIG. 10 is a graph plotting “Added Weight Load” (representing the force, in pounds, applied by six sets of levers 71/weights 81 against the pressure plate 17 of a clutch) versus rpm for three different lever/weight combinations. Each lever 71 used weighed 176 g. In the first combination, no centrifugal-assist weight 81 was added to each of the six levers 71. In the second combination, a centrifugal-assist weight 81 of 165 g was added to each of the six levers 71. In the third combination, a centrifugal-assist weight 81 of 224 g was added to each of the six levers 71. The lever/weight combinations were tested on a clutch having a 7.9 lever ratio, as will be understood by those skilled this field. It will be observed that the added weight load increases substantially as the weight of the lever 71/weight 81 increases.

In view of the above, it will be seen that the several objects of the invention are achieved and other advantageous results obtained.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense. For example, one or more lever 71 and weight 81 assemblies constructed in accordance to the present invention may be retrofit to a cover 13 of an existing clutch assembly. The clutch assembly 11 of the present invention may be used in many different applications including automotive, motorcycle, marine, industrial, or any type of application requiring a clutch assembly for transmitting torque from a driving shaft A to a driven shaft B. The present lever design may also be used with different types of clutches, coil spring clutches, push or pull clutches, single or multiple plate clutches, or any other types of lever-actuated clutches.

What is claimed is:

1. A friction clutch assembly for connecting driving and driven shafts, comprising:
a pressure plate adapted for operative attachment to said driven shaft for rotation therewith about an axis of rotation, the pressure plate being axially moveable between an engaged position wherein the pressure plate applies a force to clamp a friction disk of said driven shaft in operative engagement with a flywheel of said driving shaft thereby to transmit torque from the driving shaft to the driven shaft and a disengaged position wherein the pressure plate does not clamp said friction disk and substantially no torque is transmitted;
a cover adapted for mounting on the flywheel in a fixed axial position relative to the flywheel and for rotation in unison with the flywheel about said axis of rotation;
a thrust bearing assembly rotatable about said axis of rotation in unison with the cover and movable along said axis of rotation in a first direction toward said pressure plate and in a second direction away from said pressure plate;
a plurality of coil compression springs reacting against the cover to bias the thrust bearing assembly in said first direction;
a plurality of levers rotatable in unison with the cover, said levers being arranged around said axis of rotation and extending in generally radial directions with respect to said axis of rotation;
said levers having inner ends connected to said thrust bearing assembly such that upon movement of thrust bearing assembly in said first direction the levers are adapted to pivot in one direction to apply a generally axial force urging the pressure plate to said engaged position, and such that upon movement of thrust bearing assembly in said second direction the levers are adapted to pivot in an opposite direction to permit movement of said pressure plate to said disengaged position; and
a plurality of centrifugal-assist weights on the levers adjacent outer ends of the levers, said centrifugal-assist weights being arranged to apply an increased force urging said pressure plate to said engaged position upon rotation of the cover and the levers;
wherein each lever comprises a lever body having a fulcrum between said inner and outer ends for pivoting contact with said pressure plate; and
wherein each centrifugal-assist weight has a center of mass located a distance in the range of 1.0-1.5 in. in a radial direction outward from said fulcrum.

2. The friction clutch assembly of claim 1, wherein each centrifugal-assist weight has an overall weight in the range of 160-500 grams.

3. The friction clutch assembly of claim 1, wherein each centrifugal-assist weight is configured to match a depression contour of the pressure plate.

4. The friction clutch assembly of claim 1, wherein each centrifugal-assist weight extends laterally outward beyond opposite side edges of a respective lever body.

5. The friction clutch assembly of claim 1, wherein each lever body comprises a metal plate having a first thickness, and wherein each centrifugal-assist weight comprises a plate having a second thickness greater than the first thickness.

6. The friction clutch assembly of claim 5, wherein the outer end of each lever of said plurality of levers is received in a notch in a respective centrifugal-assist weight.

7. The friction clutch assembly of claim 6, wherein each centrifugal-assist weight has a curved outer edge centered substantially on said axis of rotation.

8. The friction clutch assembly of claim 1, wherein each centrifugal-assist weight is integrally formed as one piece with a respective lever.

9. The friction clutch assembly of claim 1, wherein each centrifugal-assist weight is formed as piece separate from a respective lever and attached to the lever.

10. The friction clutch assembly of claim 1, wherein said lever comprises a wedge-shaped lever body having a perimeter comprising an outer edge, an inner edge, and tapered side edges, and wherein said centrifugal-assist weight has a perimeter that lies outside the perimeter of the lever body adjacent an outer end of the lever body.

11. A friction clutch assembly for connecting driving and driven shafts, comprising:
a pressure plate adapted for operative attachment to said driven shaft for rotation therewith about an axis of rotation, the pressure plate being axially moveable between an engaged position wherein the pressure plate applies a force to clamp a friction disk of said driven shaft in operative engagement with a flywheel of said driving shaft thereby to transmit torque from the driving shaft to the driven shaft and a disengaged position wherein the pressure plate does not clamp said friction disk and substantially no torque is transmitted;
a cover adapted for mounting on the flywheel in a fixed axial position relative to the flywheel and for rotation in unison with the flywheel about said axis of rotation;
a thrust bearing assembly rotatable about said axis of rotation in unison with the cover and movable along said axis of rotation in a first direction toward said pressure plate and in a second direction away from said pressure plate;
a plurality of coil compression springs reacting against the cover to bias the thrust bearing assembly in said first direction;
a plurality of levers rotatable in unison with the cover, said levers being arranged around said axis of rotation and extending in generally radial directions with respect to said axis of rotation;
said levers having inner ends connected to said thrust bearing assembly such that upon movement of thrust bearing assembly in said first direction the levers are adapted to pivot in one direction to apply a generally axial force urging the pressure plate to said engaged position, and such that upon movement of thrust bearing assembly in said second direction the levers are adapted to pivot in an opposite direction to permit movement of said pressure plate to said disengaged position;
wherein each lever comprises a lever body having a fulcrum between said inner and outer ends for pivoting contact with said pressure plate; and
a plurality of centrifugal-assist weights on the levers adjacent outer ends of the levers, said centrifugal-assist weights being arranged to apply an increased force urging said pressure plate to said engaged position upon rotation of the cover and the levers; and
wherein each centrifugal-assist weight has an overall weight in the range of 160-500 grams.

12. The friction clutch assembly of claim 11, wherein said lever comprises a wedge-shaped lever body having a perimeter comprising an outer edge, an inner edge, and tapered side edges, and wherein said centrifugal-assist weight has a perimeter that lies outside the perimeter of the lever body adjacent an outer end of the lever body.

13. The friction clutch assembly of claim 11, wherein each centrifugal-assist weight extends laterally outward beyond opposite side edges of a respective lever body.

14. The friction clutch assembly of claim 11, wherein each lever body comprises a metal plate having a first thickness, and wherein each centrifugal-assist weight comprises a plate having a second thickness greater than the first thickness.

15. The friction clutch assembly of claim 11, wherein the outer end of each lever of said plurality of levers is received in a notch in a respective centrifugal-assist weight.
